(19) United States
(12) Patent Application Publication
(10) Pub. No.: US 2015/0334145 A1
(43) Pub. Date: Nov. 19, 2015

(54) Populating a Content Stream

(71) Applicant: Ranjith Jayaram, San Jose, CA (US)

(72) Inventor: Ranjith Jayaram, San Jose, CA (US)

(21) Appl. No.: 13/426,745

(22) Filed: Mar. 22, 2012

(51) Int. Cl. H04L 29/06

(52) U.S. Cl. CPC H04L 65/60; H04L 65/403; H04L 67/42

(57) ABSTRACT

A method performed by a client device, including: receiving, using the client device, a request to populate a content stream of a social networking service with content related to a media program; identifying, using the client device, in response to the request, the media program; transmitting, using the client device, to a server device configured to implement the social networking service, a request for the content, wherein the request identifies the media program; receiving, using the client device, from the server device, the content; and populating the content stream with the content.

### BACKGROUND

Generally, a broadcaster transmits media programs. Generally, a media program includes an electronic presentation for communication of information. Types of media programs include television programs, Internet programs, radio programs, and so forth.

In an example, a viewer of a television program views the television program on a television. The viewer may also use a mobile device to browse the Internet while watching television. Through the website, the viewer can email the broadcaster, post questions to forums sponsored by the broadcaster, participate in online discussions, view additional content related to the television program, and so forth.

### SUMMARY

In one aspect of the present disclosure, a method performed by a client device, includes: receiving, using the client device, a request to populate a content stream of a social networking service with content related to a media program; identifying, using the client device, in response to the request, the media program; transmitting, using the client device, to a server device configured to implement the social networking service, a request for the content, wherein the request identifies the media program; receiving, using the client device, from the server device, the content; and populating the content stream with the content.

Implementations of the disclosure can include one or more of the following features. In some implementations, the media program is accessed on a media program device by a user of the client device. In other implementations, identifying includes: receiving, from the media program device, an announcement, wherein the announcement includes a program identifier that identifies the media program. In still other implementations, identifying includes: receiving information indicative of a media program station on which the media program is accessed; and identifying the media program, based on an association between the media program station and the media program.

In some implementations, the content stream includes a type of content stream that is designated for display of information about the media program. In other implementations, the client device differs from the media program device. In still other implementations, the method includes generating data for a graphical user interface that when rendered on the client device, renders: a visual representation of the content stream.

In other implementations, the media program includes a first media program, and the method further includes: detecting that a second media program is accessed on the media program device, wherein the second media program differs from the first media program; and updating the content stream with content related to the second media program.

In yet another aspect of the disclosure, one or more machine-readable media are configured to store instructions that are executable by one or more processing devices to perform operations including receiving a request to populate a content stream of a social networking service with content related to a media program; identifying in response to the request, the media program; transmitting, to a server device configured to implement the social networking service, a request for the content, wherein the request identifies the media program; receiving, from the server device, the content; and populating the content stream with the content. Implementations of this aspect of the present disclosure can include one or more of the foregoing features.

In still another aspect of the disclosure, an electronic system includes one or more processing devices; and one or more machine-readable media configured to store instructions that are executable by the one or more processing devices to perform operations including: receiving a request to populate a content stream of a social networking service with content related to a media program; identifying in response to the request, the media program; transmitting, to a server device configured to implement the social networking service, a request for the content, wherein the request identifies the media program; receiving, from the server device, the content; and populating the content stream with the content. Implementations of this aspect of the present disclosure can include one or more of the foregoing features.

In yet another aspect of the disclosure, a method implemented by a server device, includes: receiving, using the server device, from a client device, a request for content related to a media program, wherein the request includes information that identifies a user of the client device; retrieving, using the server device, from a data repository, the content related to the media program; determining, using the server device, based on the information that identifies the user, that the user has permission to view at least a portion of the content; and outputting data for a content stream to be rendered on the client device and to be populated with at least the portion of the content; wherein the content stream is designated for display of the content related to the media program.

Implementations of the disclosure can include one or more of the following features. In some implementations, outputting includes: transmitting, to the client device, at least the portion of the content for population in the content stream. In other implementations, the method includes receiving, from the client device, a post that is related to the media program, wherein the post is tagged with a program identifier for the media program; and storing the post in the data repository, wherein the post is stored in a portion of the data repository that is associated with the program identifier. In still other implementations, the media program is accessed on a media program device by the user of the client device; and the media program device differs from the client device.

All or part of the foregoing can be implemented as a computer program product including instructions that are stored on one or more non-transitory machine-readable storage media, and that are executable on one or more processing devices. All or part of the foregoing can be implemented as an apparatus, method, or electronic system that can include one or more processing devices and memory to store executable instructions to implement the stated functions.

The details of one or more implementations are set forth in the accompanying drawings and the description below. Other features, objects, and advantages will be apparent from the description and drawings, and from the claims.

### DESCRIPTION OF DRAWINGS

FIG. 1 is a diagram of a conceptual example of a network environment for populating a content stream.

FIG. 2 is a block diagram showing examples of components of the network environment for populating a content stream.

FIG. 3 is a flowchart showing an example process for populating a content stream.

FIG. 4 shows an example of a computer device and a mobile computer device that can be used to implement the techniques described herein.

Like reference symbols in the various drawings indicate like elements.

### DETAILED DESCRIPTION

### Definitions

The term “social networking service” as used herein encompasses its plain and ordinary meaning, including, but not limited to a platform that promotes building of social connections, e.g., among people with shared interests and/or activities.

The term “social connection” as used herein encompasses its plain and ordinary meaning, including, but not limited to a relationship between nodes in a graph representing users of the social networking service.

The term “media program station” as used herein encompasses its plain and ordinary meaning, including, but not limited to a communication channel through which a media program is accessed, e.g., by the user of the system.

The term “content stream” as used herein encompasses its plain and ordinary meaning, including, but not limited to electronic (e.g., Web-based) content displayed in a portion of a graphical user interface designated for display of the electronic content, including, e.g., posts, links, images, and so forth.

The term “media program device” as used herein encompasses its plain and ordinary meaning, including, but not limited to a device configured to access a media program.

The term “now playing content stream” as used herein encompasses its plain and ordinary meaning, including, but not limited to a content stream that is designated for display of information related to a media program that is accessed on a media program device.

The term “post” as used herein encompasses its plain and ordinary meaning, including, but not limited to metadata generated by a user of the social networking service.

The term “public post” as used herein encompasses its plain and ordinary meaning, including, but not limited to a post generated by an author that is accessible to users of the social networking service, e.g., independent of whether the users have a social connection to the author.

The term “author” as used herein encompasses its plain and ordinary meaning, including, but not limited to a user of the social networking service that generates content, a user who interacted with the content, shared the content, endorsed the content, posted the content, and so forth.

The term “private post” as used herein encompasses its plain and ordinary meaning, including, but not limited to a post that is directed to a particular user or a group of users of the social networking service.

The term “social connection post” as used herein encompasses its plain and ordinary meaning, including, but not limited to a post that is accessible by users having a social connection to the author of the post.

The term “program identifier (ID)” as used herein encompasses its plain and ordinary meaning, including, but not limited to information that uniquely identifies a media program.

The term “service discovery protocol” as used herein encompasses its plain and ordinary meaning, including, but not limited to a network protocol for advertisement of information.

The term “user ID” as used herein encompasses its plain and ordinary meaning, including, but not limited to information that uniquely identifies a user, including, a login name of a user of a social networking service.

The term “processing device” as used herein encompasses its plain and ordinary meaning, including, but not limited to, one or more microprocessors, microcontrollers and/or programmable or non-programmable logic that is capable of receiving and storing data, and of communicating over a network.

The term “computing device” as used herein encompasses its plain and ordinary meaning, including, but not limited to, a programmable machine that is capable of receiving input data, processing the data, and providing an output.

### OVERVIEW

Described herein is a system that detects a media program station (e.g., a TV station, a radio station, a content website) through which a media program is accessed by a user of a social networking service. Using the detected media program station, the system is configured identify a media program that is being accessed by the user. Using an identity of the media program, the system is further configured to cause content related to the media program to be presented in a content stream of the social networking service. In this example, the electronic content is provided by the social networking service for display to a user. For example, the system is configured to populate the content stream with content related to the media program that is being accessed by the user of the system.

### Conceptual Example

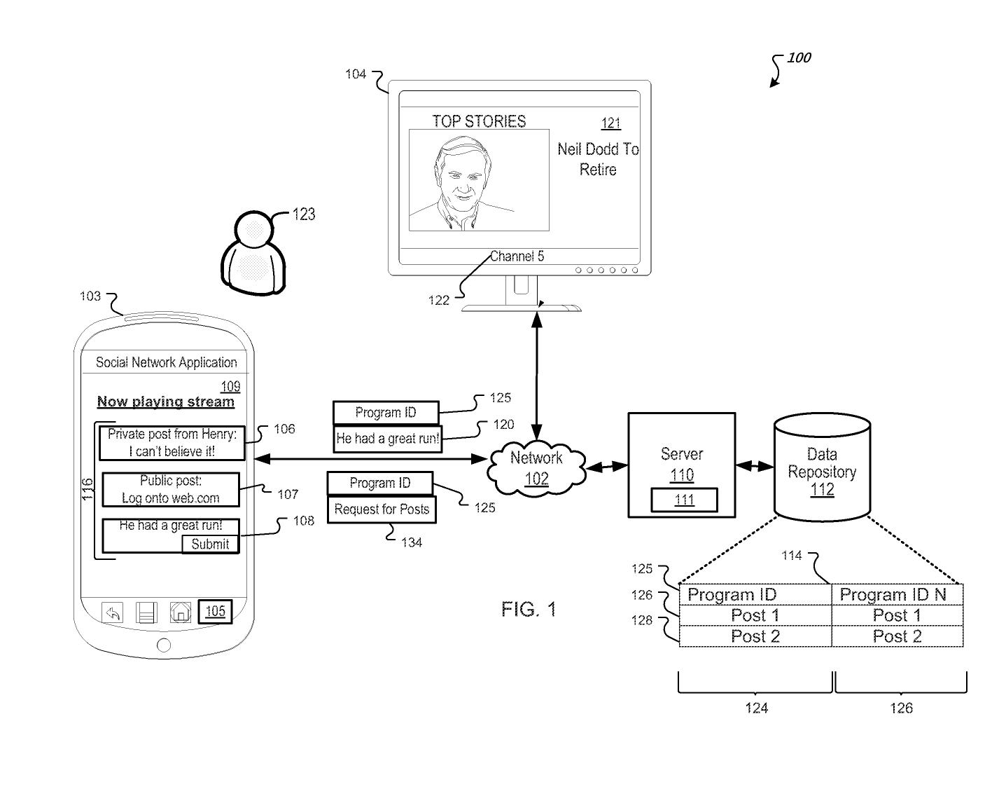

FIG. 1 is a diagram of a conceptual example of network environment 100 for populating a content stream. Network environment 100 includes network 102, client device 103, media program device 104, server 110, data repository 112, and user 123. In the example of FIG. 1, user 123 may use client device 103 and media program device 104. In an example, media program device 104 may include a device that is not under control of user 123. For example, media program device 104 may be a television in a sports bar and user 123 may be a customer of the sports bar watching the television.

Client device 103 can communicate with server 110 over network 102. Network environment 100 may include many thousands of data repositories, client devices and servers, which are not shown. Server 110 may include various data engines, including, e.g., data engine 111. Although data engine 111 is shown as a single component in FIG. 1, data engine 111 can exist in one or more components, which can be distributed and coupled by network 102.

In the example of FIG. 1, user 123 views media program 121 on media program device 104. In this example, media program device 104 accesses media program 121 from a media program station, including, e.g., media program station 122.

In an example, client device 103 includes application 105 for accessing a social networking service (not shown). In this example, the social networking service may be hosted by server 110. Application 105 generates data for displaying graphical user interface 109 on client device 103. Graphical user interface 109 can display various aspects of the social networking service, including, e.g., a listing of social connections of user 123, a listing of recent activity of user 123 in the social networking service, various content streams that are generated by the social networking service, and so forth.

In this example, the social networking service may be configured to generate various, different types of content streams. For example, the social networking service may be configured to generate a content stream for display of recent activity of users with social connections to user 123. In another example, the social networking service is configured to generate a now playing content stream.

In the example of FIG. 1, user 123 accesses media program station 122 on media program device 104, e.g., to view media program 121. In this example, user 123 instructs application 105 to display the now playing content stream for media program 121, e.g., content stream 116. In this example, content stream 116 displays content related to media program 121.

For example, content stream 116 may be populated with various types of content, including, e.g., posts, links, images, videos, and so forth. In the following examples, content stream 116 is populated with posts. In other examples, content stream 116 is populated with various, different types of content, including, e.g., posts, links, images, and/or videos (or any combination thereof).

In the example of FIG. 1, content stream 116 is populated with various types of posts, including, e.g., public posts related to media program 121, private posts related to media program 121 (e.g., when user 123 has appropriate permissions to view the private posts), social connections posts related to media program 121, and so forth. As previously described, user 123 requests that application 105 generate data for displaying content stream 116 in graphical user interface 109. In this example, application 105 is configured to identify that user 123 accesses media program 121 through media program station 122 on media program device 104. To identify that media program 121 is accessed, application 105 is configured to retrieve program ID 125 for media program 121. In this example, program ID 125 includes a name of media program 121.

Application 105 is configured to use various techniques in identifying program ID 125 for media program 121. In the example of FIG. 1, media program device 104 includes an internet protocol enabled device. In this example, media program device 104 uses a service discovery protocol to announce (e.g., via network 102) that program ID 125 is associated with media program 121. In this example, application 105 receives from media program device 104 an announcement (e.g., a message) including program ID 125 for media program 121, e.g., via network 102.

In another example, media program device 104 includes a device that is not an internet protocol enabled device. In this example, application 105 implements various techniques in determining that media program 121 is associated with program ID 125. In an example, application 105 may generate data for displaying a graphical user interface (not shown) on client device 103, e.g., for selection of media program stations being accessed by user 123. Through the graphical user interface, user 123 selects data indicating that media program station 122 is being accessed by user 123 on media program device 104. Based on the selection, application 105 identifies program ID 125 for media program 121, e.g., using the below-described techniques.

In an example, application 105 accesses, via network 102, an online repository (not shown) storing information indicative of associations among program IDs for media programs and various media program stations (e.g., an online TV guide). Using the selection of media program station 122, application 105 is configured to lookup in the online repository that media program 121 is being shown on media program station 122, e.g., at a time when user 123 made the above-described selection through the graphical user interface. Using the online repository, application 105 also determines that program ID 125 is associated with media program 121.

In another example, user 123 provides application 105 with program ID 125 for media program 121, e.g., by using a microphone (not shown) to verbally input program ID 125 into client device 103. Using voice recognition techniques, application 105 is configured to recognize program ID 125.

In still another example, user 123 provides application 105 with a name of media program station 122. In this example, application 105 uses the name of media program station 122 in identifying program ID 125 for media program 121. Using the name of media program station 122, application 105 is configured to lookup in the online repository program ID 125 for media program 121, e.g., at a time when user 123 spoke the name of media program station 122 into the microphone of client device 103.

In an example, user 123 provides application 105 with a sound sample from media program 121. In this example, user 123 may place a microphone on client device 103 in proximity to a speaker (not shown) on media program device 104. In another example, application 105 is configured to automatically obtain the sound sample, e.g., by listening to ambient sound for media program 121 and attempting to recognize media program 121. In still another example, application 105 is configured to perform automatic station recognition, e.g., by receiving audio data generated by speakers of media program device 104.

Using network 102, application 105 sends the sound sample to a system (not shown) that is configured to identify program IDs of media programs from sound samples. In an example, the system is external to network environment 100. In another example, the system is internal to network environment 100. In this example, application 105 receives, from the system, program ID 125 of media program 121.

Following identification of program ID 125 for media program 121, application 105 sends request 134 to server 110. Request 134 includes a request for posts that are related to media program 121. In the example of FIG. 1, request 134 is tagged with program ID 125 to identify that media program 121 is being accessed by user 123. In response to request 134, server 110 identifies posts that are associated with program ID 125 and that user 123 has permission to view.

In this example, data repository 112 is configured to store table 114. In the example of FIG. 1, table 114 includes associations among posts and program IDs. For example, portion 124 of table 114 includes associations among program ID 125 and posts 126, 128 that are related to program ID 125. Portion 126 of table 114 includes associations among another, different program ID (e.g., program ID N) and posts that are related to the other program ID.

Following receipt of request 134 and program ID 125 from client device 103, data engine 111 queries data repository 112 for posts 126, 128 that are related to program ID 125. In this example, data engine 111 determines that posts 126, 128 are associated with program ID 125.

In a variation, data engine 111 may be configured to query data repository 112 for posts 126, 128 that are related to media program 121. In this example, data repository 112 may be configured to store posts in association with various media programs, including, e.g., media program 121.

In the example of FIG. 1, posts 126, 128 are associated with a permission level, e.g., information specifying whether the post is a public post, a private post, a social connection post, and so forth. In this example, when client device 103 sends request 134 and program ID 125 to server 110, client device 103 also sends a user ID (not shown) for user 123. Using the user ID for user 123, data engine 111 identifies which of posts 126, 128 user 123 has permission to view.

In an example, user 123 has permission to view public posts associated with media program 121. User 123 also has permission to view private posts associated with media program 121 that were sent to user 123. User 123 also has permission to view social connection posts associated with media program 121 that were generated by users having a social connection to user 123. In this example, user 123 may not have permission to view private posts that were sent to other users of the social networking service. User 123 may also not have permission to view social connections posts that were generated by users that do not have a social connection to user 123.

Using the user ID for user 123 and the permission levels of posts 126, 128, data engine 111 identifies that user 123 has permission to view posts 126, 128. Server 110 sends information indicative of posts 126, 128 to client device 103. In response, application 105 generates information for updating content stream 116 with posts 126, 128. In the example of FIG. 1, application 105 generates visual representations 106, 107 of posts 126, 128, respectively. Application 105 populates content stream 116 with visual representations 106, 107.

In an example, content stream 116 also includes portion 108. Through portion 108, user 123 may submit a post about media program 121. In the example of FIG. 1, user 123 enters information into portion 108. In this example, the entered information includes the words “he had a great run!”

Following entry of the information into portion 108, application 105 generates post 120, which includes the information entered into portion 108 of graphical user interface 109. In this example, application 105 tags post 120 with program ID 125.

Client device 103 sends post 120 tagged with program ID 125 to server 110. Data engine 111 determines that program ID 125 is associated with post 120. Based on the determined association, data engine 111 inserts (not shown) post 120 into portion 124 of table 114, e.g., to generate an association between post 120 and program ID 125.

In an example, application 105 is configured to detect when user 123 changes from media program station 122 to a new, different media program station. In an example, media program device 104 includes an internet protocol enabled device. In this example, application 105 detects a change in media program stations by receiving, from media program device 104, an announcement including information indicative of the change. In response to detection of the change, application 105 is configured to update content stream 116 with content that is associated with the media program being shown on the new media program station.

In another example, application 105 detects a change in media program stations when user 123 provides application 105 with information indicative of the change. In this example, media program device 104 includes a non-internet protocol enabled device. In this example, application 105 may generate data for a graphical user interface, e.g., through which user 123 selects data indicative of a media program station accessed through media program device 104. In this example, application 105 detects a change in media program stations by receiving through the graphical user interface a selection of data indicative of a new media program station.

In another example, application 105 detects a change in media program stations when user 123 speaks into a microphone of client device 103 a name of a new media program station. In still another example, application 105 detects a change in media program stations when user 123 provides application 105 with a sound sample from a media program being shown on the new media program station. Application 105 may also detect a change in media program stations based on changes in ambient noise, for which application 105 is configured to listen.

When application 105 detects a change from media program station 122 to a new media program station, application 105 determines a program ID for a media program accessed on the new media program station. Client device 103 sends the program ID to server 110 to retrieve posts associated with the media program on the new media program station. Using the retrieved posts, application 105 updates content stream 116, e.g., in real-time and with posts that are related to the media program being accessed on the new media program station.

In a variation of FIG. 1, server 110 receives numerous posts (e.g., hundreds of posts, thousands of posts, and so forth) about media program 121. In this example, server 110 receives posts from numerous, different types of users of the social networking service, including, e.g., consumers of media programs, providers of media programs, actors that are featured in media programs, and so forth.

In this example, the numerous posts about media program 121 are tagged with program ID 125. For example, the posts may be tagged with program ID 125 by numerous instances of application 105 that are being executed on numerous client devices from which the posts are submitted. In this example, server 110 collects the numerous posts associated with program ID 125 and stores the numerous posts in table 114.

In an example, server 110 receives new posts associated with program ID 125. In this example, the new posts include posts other than posts 126, 128. Server 110 sends, to client device 103, information indicative of the new posts, e.g., to promote content stream 116 being updated in real-time as server 110 receives new posts that are associated with program ID 125.

### Example System Implementation

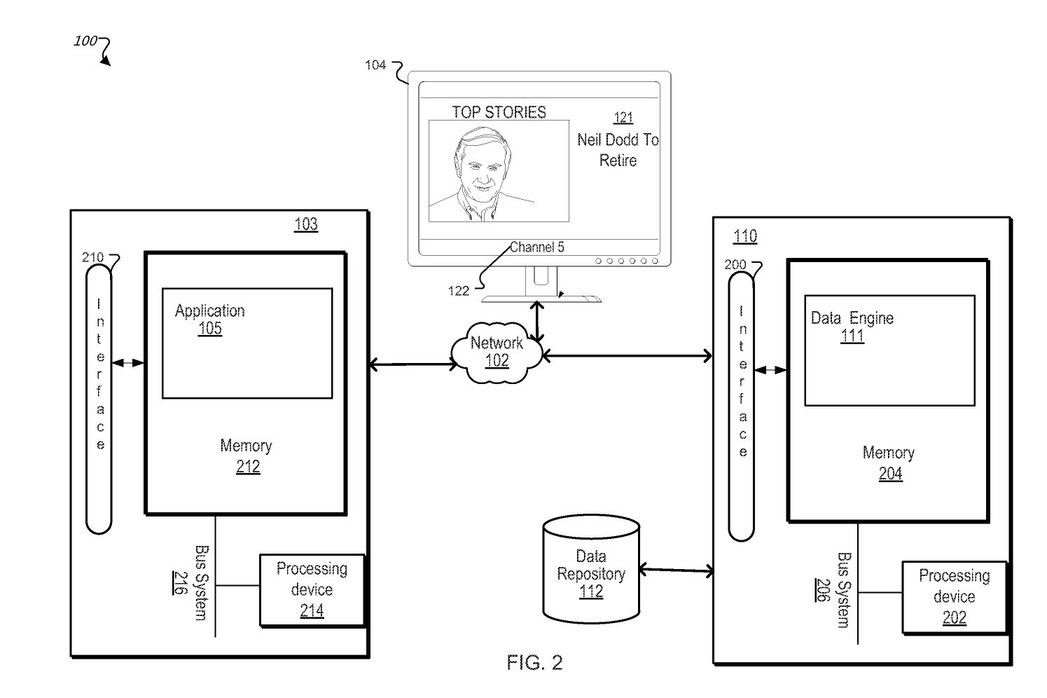

FIG. 2 is a block diagram showing examples of components of network environment 100 for populating content stream 116. In the example of FIG. 2, graphical user interface 109, contents of graphical user interface 109, user 123, program ID 125, post 120, request 134, table 114 and contents of table 114 are not shown.

Client device 103 can be a computing device capable of taking input from user 123 (FIG. 1) and communicating over network 102 with server 110 and/or with other computing devices. For example, client device 103 can be a mobile device, a desktop computer, a laptop, a cell phone, a personal digital assistant (PDA), a server, an embedded computing system, a mobile device, and the like. Network environment 100 can include a plurality of computing devices, which can be geographically dispersed.

Network 102 can include a large computer network, including, e.g., a local area network (LAN), wide area network (WAN), the Internet, a cellular network, or a combination thereof connecting a number of mobile computing devices, fixed computing devices, and server systems. The network(s) may provide for communications under various modes or protocols, including, e.g., Transmission Control Protocol/Internet Protocol (TCP/IP), Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, or General Packet Radio System (GPRS), among others. Communication may occur through a radio-frequency transceiver. In addition, short-range communication may occur, including, e.g., using a Bluetooth, WiFi, or other such transceiver.

Server 110 can be a variety of computing devices capable of receiving data and running one or more services, which can be accessed by client device 103. In an example, server 110 can include a server, a distributed computing system, a desktop computer, a laptop, a cell phone, a rack-mounted server, and the like. Server 110 can be a single server or a group of servers that are at a same location or at different locations. Client device 103 and server 110 can run programs having a client-server relationship to each other. Although distinct modules are shown in the figures, in some examples, client and server programs can run on the same device.

Server 110 can receive data from client device 103 (and/or from data repository 112) through input/output (I/O) interface 200. I/O interface 200 can be a type of interface capable of receiving data over a network, including, e.g., an Ethernet interface, a wireless networking interface, a fiber-optic networking interface, a modem, and the like. Server 110 also includes a processing device 202 and memory 204. A bus system 206, including, for example, a data bus and a motherboard, can be used to establish and to control data communication between the components of server 110.

Processing device 202 can include one or more microprocessors. Memory 204 can include a hard drive and a random access memory storage device, including, e.g., a dynamic random access memory, or other types of non-transitory machine-readable storage devices. As shown in FIG. 2, memory 204 stores computer programs that are executable by processing device 202. These computer programs include data engine 111. Data engine 111 can be implemented in software running on a computer device (e.g., server 110), hardware or a combination of software and hardware.

Client device 103 can receive data from server 110 and from media program device 104 through I/O interface 210. Client device 103 also includes a processing device 214 and memory 212. A bus system 216, including, for example, a data bus and a motherboard, can be used to establish and to control data communication between the components of client device 103. As shown in FIG. 2, memory 212 stores computer programs that are executable by processing device 214. These computer programs include application 105.

### Example Process

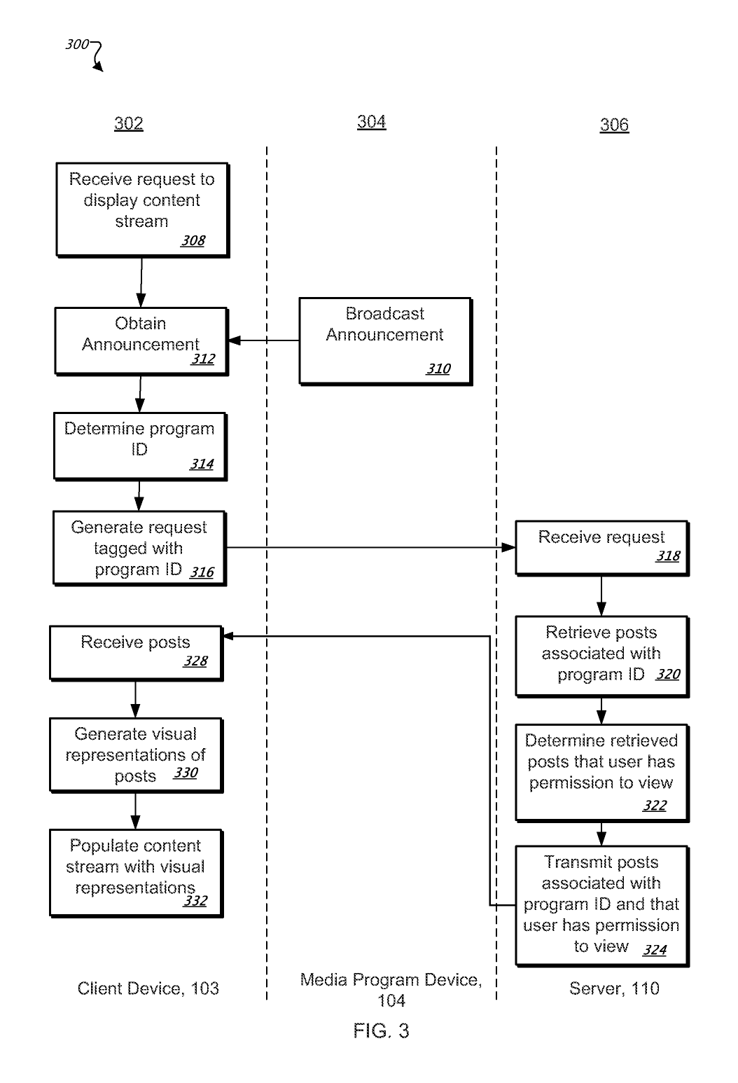

FIG. 3 is a flowchart showing an example process 300 for populating content stream 116. In FIG. 3, process 300 is split into a left part 302, which is performed on client device (e.g., client device 103—and/or by application 105 on client device 103), a center part 304, which is performed on media program device (e.g. media program device 104), and a right part 306, which is performed on server (e.g., server 110—and/or by data engine 111 on server 110).

In operation, a request (not shown) to display content stream 116 is received (308). For example, application 105 receives (308) a request (not shown) to display content stream 116. In this example, application 105 receives the request in response to user 123 selecting a control in graphical user interface 109, e.g., a control for displaying content stream 116.

An announcement (not shown) from media program device 104 is obtained (312). For example, in response to the request, application 105 obtains (312) the announcement from media program device 104. In this example, media program device 104 includes an internet protocol enabled device. The announcement is broadcast (310). For example, media program device 104 broadcasts (310) the announcement to client device 103, e.g., via a local network (not shown). In this example, the announcement is broadcast on the local network (not shown) that media program device 104 and client device 103 are on. Client device 103 receives the announcement by virtue of the fact that client device 103 is on the same local network as media program device 104. In this example, the announcement includes program ID 125 for media program 121.

Program ID 125 for media program 121 is determined (314). For example, using contents of the announcement, application 105 determines (314) program ID 125 for media program 121. Request 134 is generated (316). For example, to populate content stream 116 with posts 126, 128 that are related to media program 121, application 105 generates (316) request 134 and tags request 134 with program ID 125.

Client device 103 transmits (not shown), to server 110, request 134 tagged with program ID 125. In an example, request 134 also includes a user ID (not shown) for user 123, for example, as previously described. Request 134 tagged with program ID 124 and user ID is received (318). For example, server 110 receives (318) request 134 tagged with program ID 124 and user ID. Posts 126, 128 that are associated with program ID 125 are retrieved (320). For example, in response to receipt of request 134, data engine 111 retrieves (320) from data repository 112 posts 126, 128 that are associated with program ID 125.

Posts 126, 128 are determined to be accessible to user 123 (322). For example, from the retrieved posts 126, 128, data engine 111 determines (322) which of posts 126, 128 user 123 has permission to view. In this example, data engine 111 determines permission levels of posts 126, 128. In an example, posts 126, 128 include a social content post and private post, respectively. In this example, data engine 111 compares the permission levels of posts 126, 128 to the user ID for user 123. Based on the comparison, data engine 111 determines that user 123 has permission to view posts 126, 128. Posts 126, 128 are transmitted (324). For example, data engine 111 transmits (324) posts 126, 128 to client device 103.

Posts 126, 128 are received (328). For example, client device 103 receives (328) posts 126, 128. Visual representations 106, 107 of posts 126, 128 are generated (330). For example, application 105 generates (330) visual representations 106, 107 of posts 126, 128, respectively. Content stream 116 is populated with visual representations 106, 107 (322). For example, application 105 populates (332) content stream 116 with visual representations 106, 107.

In a variation of FIG. 3, media program device 104 includes a non-internet protocol enabled device. In this example, application 105 determines program ID 125 for media program 121 using one of the above-described techniques. For example, application 105 may determine program ID 125 based on a sound sample of media program 121, e.g., that is provided by user 123.

### Example Alternative System Implementations

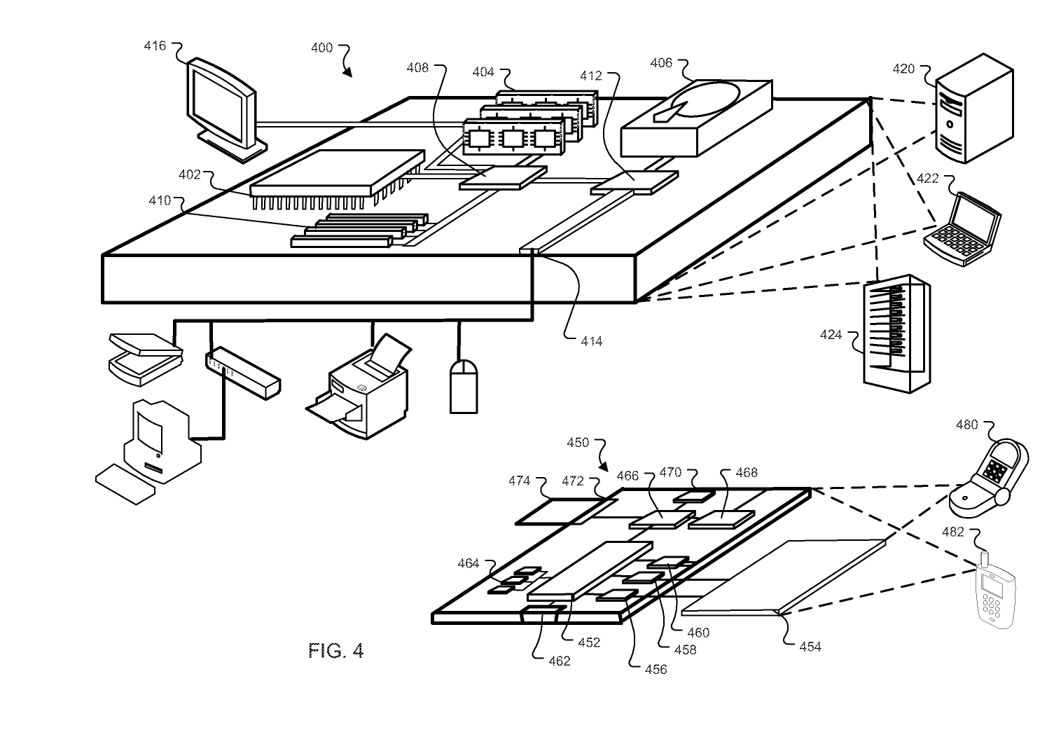

FIG. 4 shows an example of computer device 400 and mobile computer device 450, which can be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be examples only, and are not meant to limit implementations of the techniques described and/or claimed in this document.

Computing device 400 includes processor 402, memory 404, storage device 406, high-speed interface 408 connecting to memory 404 and high-speed expansion ports 410, and low speed interface 412 connecting to low speed bus 414 and storage device 406. Each of components 402, 404, 406, 408, 410, and 412, are interconnected using various busses, and can be mounted on a common motherboard or in other manners as appropriate. Processor 402 can process instructions for execution within computing device 400, including instructions stored in memory 404 or on storage device 406 to display graphical data for a GUI on an external input/output device, such as display 416 coupled to high speed interface 408. In other implementations, multiple processors and/or multiple buses can be used, as appropriate, along with multiple memories and types of memory. Also, multiple computing devices 400 can be connected, with each device providing portions of the necessary operations (e.g., as a server bank, a group of blade servers, or a multi-processor system).

Memory 404 stores data within computing device 400. In one implementation, memory 404 is a volatile memory unit or units. In another implementation, memory 404 is a non-volatile memory unit or units. Memory 404 also can be another form of computer-readable medium, such as a magnetic or optical disk.

Storage device 406 is capable of providing mass storage for computing device 400. In one implementation, storage device 406 can be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in a data carrier. The computer program product also can contain instructions that, when executed, perform one or more methods, such as those described above. The data carrier is a computer- or machine-readable medium, such as memory 404, storage device 406, memory on processor 402, and the like.

High-speed controller 408 manages bandwidth-intensive operations for computing device 400, while low speed controller 412 manages lower bandwidth-intensive operations. Such allocation of functions is an example only. In one implementation, high-speed controller 408 is coupled to memory 404, display 416 (e.g., through a graphics processor or accelerator), and to high-speed expansion ports 410, which can accept various expansion cards (not shown). In the implementation, low-speed controller 412 is coupled to storage device 406 and low-speed expansion port 414. The low-speed expansion port, which can include various communication ports (e.g., USB, Bluetooth®, Ethernet, wireless Ethernet), can be coupled to one or more input/output devices, such as a keyboard, a pointing device, a scanner, or a networking device such as a switch or router, e.g., through a network adapter.

Computing device 400 can be implemented in a number of different forms, as shown in the figure. For example, it can be implemented as standard server 420, or multiple times in a group of such servers. It also can be implemented as part of rack server system 424. In addition or as an alternative, it can be implemented in a personal computer such as laptop computer 422. In some examples, components from computing device 400 can be combined with other components in a mobile device (not shown), such as device 450. Each of such devices can contain one or more of computing device 400, 450, and an entire system can be made up of multiple computing devices 400, 450 communicating with each other.

Computing device 450 includes processor 452, memory 464, an input/output device such as display 454, communication interface 466, and transceiver 468, among other components. Device 450 also can be provided with a storage device, such as a microdrive or other device, to provide additional storage. Each of components 450, 452, 464, 454, 466, and 468, are interconnected using various buses, and several of the components can be mounted on a common motherboard or in other manners as appropriate.

Processor 452 can execute instructions within computing device 450, including instructions stored in memory 464. The processor can be implemented as a chipset of chips that include separate and multiple analog and digital processors. The processor can provide, for example, for coordination of the other components of device 450, such as control of user interfaces, applications run by device 450, and wireless communication by device 450.

Processor 452 can communicate with a user through control interface 458 and display interface 456 coupled to display 454. Display 454 can be, for example, a TFT LCD (Thin-Film-Transistor Liquid Crystal Display) or an OLED (Organic Light Emitting Diode) display, or other appropriate display technology. Display interface 456 can comprise appropriate circuitry for driving display 454 to present graphical and other data to a user. Control interface 458 can receive commands from a user and convert them for submission to processor 452. In addition, external interface 462 can communicate with processor 442, so as to enable near area communication of device 450 with other devices. External interface 462 can provide, for example, for wired communication in some implementations, or for wireless communication in other implementations, and multiple interfaces also can be used.

Memory 464 stores data within computing device 450. Memory 464 can be implemented as one or more of a computer-readable medium or media, a volatile memory unit or units, or a non-volatile memory unit or units. Expansion memory 474 also can be provided and connected to device 450 through expansion interface 472, which can include, for example, a SIMM (Single In Line Memory Module) card interface. Such expansion memory 474 can provide extra storage space for device 450, or also can store applications or other data for device 450. Specifically, expansion memory 474 can include instructions to carry out or supplement the processes described above, and can include secure data also. Thus, for example, expansion memory 474 can be provide as a security module for device 450, and can be programmed with instructions that permit secure use of device 450. In addition, secure applications can be provided via the SIMM cards, along with additional data, such as placing identifying data on the SIMM card in a non-hackable manner.

The memory can include, for example, flash memory and/or NVRAM memory, as discussed below. In one implementation, a computer program product is tangibly embodied in an data carrier. The computer program product contains instructions that, when executed, perform one or more methods, such as those described above. The data carrier is a computer- or machine-readable medium, such as memory 464, expansion memory 474, and/or memory on processor 452, that can be received, for example, over transceiver 468 or external interface 462.

Device 450 can communicate wirelessly through communication interface 466, which can include digital signal processing circuitry where necessary. Communication interface 466 can provide for communications under various modes or protocols, such as GSM voice calls, SMS, EMS, or MMS messaging, CDMA, TDMA, PDC, WCDMA, CDMA2000, or GPRS, among others. Such communication can occur, for example, through radio-frequency transceiver 468. In addition, short-range communication can occur, such as using a Bluetooth®, WiFi, or other such transceiver (not shown). In addition, GPS (Global Positioning System) receiver module 470 can provide additional navigation- and location-related wireless data to device 450, which can be used as appropriate by applications running on device 450.

Device 450 also can communicate audibly using audio codec 460, which can receive spoken data from a user and convert it to usable digital data. Audio codec 460 can likewise generate audible sound for a user, such as through a speaker, e.g., in a handset of device 450. Such sound can include sound from voice telephone calls, can include recorded sound (e.g., voice messages, music files, and the like) and also can include sound generated by applications operating on device 450.

Computing device 450 can be implemented in a number of different forms, as shown in the figure. For example, it can be implemented as cellular telephone 480. It also can be implemented as part of smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying data to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the engines described herein can be separated, combined or incorporated into a single or combined engine. The engines depicted in the figures are not intended to limit the systems described here to the software architectures shown in the figures.

For situations in which the systems and techniques discussed herein collect personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (e.g., to a city, zip code, or state level), so that a particular location of the user cannot be determined.

All processes described herein and variations thereof (referred to as “the processes”) contain functionality to ensure that party privacy is protected. To this end, the processes may be programmed to confirm that a user's membership in a social networking account is publicly known before divulging, to another party, that the user is a member. Likewise, the processes may be programmed to confirm that information about a party is publicly known before divulging that information to another party, or even before incorporating that information into a social graph.

A number of embodiments have been described. Nevertheless, it will be understood that various modifications can be made without departing from the spirit and scope of the processes and techniques described herein. In addition, the logic flows depicted in the figures do not require the particular order shown, or sequential order, to achieve desirable results. In addition, other steps can be provided, or steps can be eliminated, from the described flows, and other components can be added to, or removed from, the described systems. Accordingly, other embodiments are within the scope of the following claims.

1. A method comprising:
receiving, using a client device, a request to populate a content stream of a social networking service with a content related to a media program;
obtaining, using the client device, a sound sample from the media program;
identifying, using the client device, in response to the request, the media program based on the sound sample;
transmitting, using the client device, to a server device configured to implement the social networking service, a request for the content related to the media program, the request for the content identifying the media program;
receiving, using the client device, from the server device, the content related to the media program;
populating the content stream of the social networking service with the content related to the media program; and
providing the populated content stream including the content related to the media program for display.

2. The method of claim 1, wherein the media program is accessed on a media program device by a user of the client device.

3. The method of claim 2, wherein identifying comprises:
receiving, from the media program device, an announcement, wherein the announcement comprises a program identifier that identifies the media program.

4. The method of claim 1, wherein identifying comprises:
receiving information indicative of a media program station on which the media program is accessed; and
identifying the media program, based on an association between the media program station and the media program.

5. The method of claim 1, wherein the content stream of the social networking service comprises a type of content stream that is designated for display of information about the media program.

6. The method of claim 2, wherein the client device differs from the media program device.

7. The method of claim 1, further comprising:
generating data for a graphical user interface that when rendered on the client device, renders:
a visual representation of the content stream of the social networking service.

8. The method of claim 2, wherein the media program comprises a first media program, and wherein the method further comprises:
detecting that a second media program is accessed on the media program device, wherein the second media program differs from the first media program; and
updating the content stream of the social networking service with a content related to the second media program.

9. A method comprising:
receiving, using a server device, from a client device, a request for a content related to a media program, wherein the request comprises information that identifies a user of the client device and the media program is identified based on a sound sample from the media program;
retrieving, using the server device, from a data repository, the content related to the media program;
determining, using the server device, based on the information that identifies the user, that the user has permission to view at least a portion of the content related to the media program; and
outputting data for a content stream of a social networking service to be rendered on the client device and to be populated with at least the portion of the content related to the media program;
wherein the content stream of the social networking service is designated for display of the content related to the media program.

10. The method of claim 9, wherein outputting comprises:
transmitting, to the client device, at least the portion of the content related to the media program for population in the content stream of the social networking service.

11. The method of claim 9, further comprising:
receiving, from the client device, a post that is related to the media program, wherein the post is tagged with a program identifier for the media program; and
storing the post in the data repository, wherein the post is stored in a portion of the data repository that is associated with the program identifier.

12. The method of claim 9, wherein the media program is accessed on a media program device by the user of the client device; and
wherein the media program device differs from the client device.

13. One or more machine-readable media configured to store instructions that are executable by one or more processing devices to perform operations comprising:
receiving a request to populate a content stream of a social networking service with a content related to a media program;
obtaining a sound sample from the media program;
identifying in response to the request, the media program based on the sound sample;
transmitting to a server device configured to implement the social networking service, a request for the content related to the media program, wherein the request identifies the media program;
receiving from the server device, the content related to the media program;
populating the content stream of the social networking service with the content related to the media program; and
providing the populated content stream including the content related to the media program for display.

14. The one or more machine-readable media of claim 13, wherein the media program is accessed on a media program device by a user of the client device.

15. The one or more machine-readable media of claim 14, wherein identifying comprises:
receiving, from the media program device, an announcement, wherein the announcement comprises a program identifier that identifies the media program.

16. The one or more machine-readable media of claim 13, where identifying comprises:
receiving information indicative of a media program station on which the media program is accessed; and
identifying the media program, based on an association between the media program station and the media program.

17. The one or more machine-readable media of claim 13, wherein the content stream of the social networking service comprises a type of content stream that is designated for display of information about the media program.

18. An electronic system comprising:
one or more processing devices; and
one or more machine-readable media configured to store instructions that are executable by the one or more processing devices to perform functions comprising:
receiving a request to populate a content stream of a social networking service with a content related to a media program;
obtaining a sound sample from the media program;
identifying in response to the request, the media program based on the sound sample;
transmitting, to a server device configured to implement the social networking service, a request for the content related to the media program, wherein the request identifies the media program;
receiving from the server device, the content related to the media program;
populating the content stream of the social networking service with the content related to the media program; and
providing the populated content stream including the content related to the media program for display.

19. The electronic system of claim 18, wherein the media program is accessed on a media program device by a user of the client device.

20. The electronic system of claim 19, wherein identifying comprises:
receiving, from the media program device, an announcement, wherein the announcement comprises a program identifier that identifies the media program.

21. The electronic system of claim 18, where identifying comprises:
receiving information indicative of a media program station on which the media program is accessed; and
identifying the media program, based on an association between the media program station and the media program.

22. The electronic system of claim 18, wherein the content stream of the social networking service comprises a type of content stream that is designated for display of information about the media program.
